(19) United States
(12) Patent Application Publication
(10) Pub. No.: US 2003/0143316 A1
(43) Pub. Date: Jul. 31, 2003

(54) Process and apparatus for the production of biopolymer arrays

(76) Inventors: Heinz Eipel, Bensheim (DE); Stefan Matysiak, Tettnang (DE)

Correspondence Address: Keil & Weinkauf, 1101 Connecticut Avenue NW, Washington, DC, 20036, US

(21) Appl. No.: 10/240,680

(22) PCT Filed: Apr. 6, 2001
(86) PCT No.: PCT/EP01/03999

(30) Foreign Application Priority Data
Apr. 6, 2000 (DE) 100 17 105.2

(51) Int. Cl. B05D 3/00; G01D 15/04; G01D 15/20

(52) U.S. Cl. 427/2.11; 346/106

(57) ABSTRACT

The invention relates to a process and an apparatus for producing biopolymer fields (15) on support substrates (4), (14), where the biopolymers to be applied can be taken from one or more different biopolymer stocks. A multidimensionally movable capillary tip (1) of a capillary tube (2) is, for the transfer of extremely small liquid quantities to substrate surfaces (14), addressed via a miniature valve (5) serving for filling and a miniature valve (7) serving for rinsing of the capillary tube (2).

The invention relates to a process and an apparatus for the production of biopolymer fields (arrays) of nucleic acids, proteins and/or polysaccharides for the arrangement of sample quantities of these substances on a support or support material.

For the highly parallel analysis of biopolymers—for example nucleic acids, proteins and/or polysaccharides—arrangements of a large number of small quantities of sample in drop form are generally applied to flat supports or support substances. Supports used for the sample quantities to be employed are plastic films, membranes or specimen slides, as frequently employed in microscopy. In typical analysis applications, from a few hundred to a few thousand analysis spots are applied to a support.

For the application of the extremely small amounts of liquid of the samples to be analyzed in the range from a few picoliters to a few nanoliters to supports or support materials, use is made, for example, of ink-jet printing technology. In ink-jet printing technology, the quantities to be applied of the sample liquids to be analyzed are subjected to relatively large mechanical and/or thermal stresses, which may impair the sensitive biopolymers. Furthermore in this application technique, undesired formation of gas bubbles can frequently occur, which hinders precise positioning of the liquid drops and thus a regularly arranged analysis field. Furthermore, defects can frequently occur through the viscosities of the liquid quantities to be applied being very different.

M. Schena et al., Science 270, 1995, pp. 467-470, discloses a process which is based on the fountain pen method. In this solution, which is known from the prior art, metal pins with shaped pin tips are employed. These pins are dipped into the liquid to be pipetted; some of the liquid to be applied remains on the surface of the pin tip; when the pin tip is later lowered, this liquid is transferred onto the support or support material surface to be charged. A disadvantage in this technique is the restricted liquid accommodation capacity of the shaped pin tip if, after take-up of the liquid, a large number of support surfaces are to be spotted in order to form respective arrays to be analyzed, each with the same pattern.

If grooves or slots are provided on the metal pin tips to be immersed into the sample containers in order to increase the accommodation capacity for the liquid to be applied, these have the disadvantage of more difficult and inconvenient cleaning. However, cleaning is vital in order to avoid entrainment of sample substance if the metal pin tips are in each case dipped into a container with a new type of sample and residues of the substrate previously applied still adhere to the tip, so that the new sample spot on the substrate is not contaminated with substances from the previously transferred spot.

In view of the indicated disadvantages of the solutions known from the prior art, the object of the present invention was to arrange, inexpensively and reliably, using simple means, biopolymer fields or arrays to be analyzed.

This object is achieved in accordance with the invention in that, in a process for the generation of biopolymer areas on support substrates, where the biopolymers to be applied are to be taken from one or more sample stocks, a multidimensionally movable capillary tip of a capillary tube is, for the transfer of extremely small amounts of liquid onto substrate surfaces, addressed via a miniature valve serving for filling and via a further miniature valve serving for rinsing.

The advantages of this solution may be regarded, in particular, as being that the process proposed in accordance with the invention allows a multiplicity of support substance plates to be charged in a simple manner with a single capillary filling. In order to avoid sample entrainment, two rinsing operations on the capillaries have proven sufficient in practice to exclude cross-contamination of the sample stocks and the transferred samples. On the other hand, the rinsing of the capillaries in each case taking up the sample amount stock can be repeated as often as desired through the two independently addressable miniature valves.

In a further embodiment of the process on which the invention is based, a plurality of capillary tubes can be connected to the miniature valves. This enables parallel application of a plurality of extremely small quantities of liquid to the surface of a substrate or substrate material.

If a plurality of capillary tubes are employed at a distance of the container vessels from one another, a larger number of liquid samples to be analyzed can be applied simultaneously through parallel treatment of a plurality of support surfaces.

In accordance with a further advantageous refinement of the thought on which the invention is based, the plurality of capillary tubes can be arranged in such a way with respect to one another that their separation from one another corresponds to the separations of two sample quantities of biopolymer substances with which these are applied to the surface of the support substrate.

The more regular the arrangement of the extremely small liquid quantities to be analyzed is on the surface of the substrate support, the more accurately evaluation of the liquid samples applied can be carried out and the more easily a subsequent analysis method can be automated.

In a preferred embodiment of the process proposed in accordance with the invention, the one or the plurality of capillary tubes can be moved in the X- or Y-direction, it furthermore being possible for an immersion movement in the Z-direction to be carried out in order to accommodate a liquid stock from a substrate container. The addressability of the respective capillary tubes in the three coordinate directions enables maximum utilization of the space on analysis plates. For the addressing and movability of the one or more capillary tubes which apply the extremely small liquid quantities to be analyzed onto the respective support surfaces, a commercially available computer-supported plotter which can be moved in the X-direction and Y-direction is advantageously employed. Through the addressing of a commercially available plotter by means of a personal computer (PC), inexpensive movability and reliable addressability of the one or more capillary tubes can be achieved.

Instead of a commercially available plotter with which movability of the one or more capillary tubes in the X-direction or Y-direction can be achieved, computer-supported positioning stages can also be employed.

In accordance with the invention, an apparatus for generating biopolymer fields on support substrates is furthermore proposed, where the biopolymers to be applied can be taken from one or more different sample stocks, where a capillary tube glass tip which can be moved in a number of directions for the transfer of extremely small liquid quantities onto substrate surfaces can be addressed via a miniature valve serving for filling and via a miniature valve serving for rinsing of the capillary. In a further embodiment of the apparatus for the generation of biopolymer fields which is proposed in accordance with the invention, the capillary tips are drawn out at the ends accommodating extremely small liquid quantities to an external diameter in the range between 10 μm and 1000 μm. In a particularly preferred embodiment, the capillary tips are designed at the end respectively accommodating the extremely small liquid quantities in an external diameter of from 50 μm to 300 μm.

The addressing of the one or more capillary tubes can be carried out by means of a computer-supported plotter, which generates movement of the capillary tube(s) in the respective X- or Y-direction and an immersion movement of the capillary tubes together with the liquid stock accommodated therein in the Z-direction in order to apply extremely small liquid quantities onto the surfaces of supports or support materials. In an embodiment proposed in accordance with the invention, the miniature valves provided in the line system to the capillary tube can be designed as constricted tube valves. In these, it can be provided, in particular, that the flexible tube line is supported by a fixed stop opposite which a flexible stop is provided by means of which the cross section of the flexible tube line can be closed. The original cross section of the flexible line is restored automatically owing to the elasticity of the tube material.

The invention is explained in greater detail below with reference to the drawing, which comprises a single FIGURE.

The single FIGURE shows an apparatus for carrying out the process proposed in accordance with the invention, in which the capillary tube together with the capillary tube tip can be moved in three directions.

The depiction in the single FIGURE shows a capillary tube 2—preferably consisting of glass—which serves for accommodation of a biopolymer solution to be pipetted. This is dipped into a sample quantity container 3, also referred to as microtiter plate well. The opening of the first miniature valve 5—designed, for example, as a constricted tube valve—to the atmosphere 6 causes pressure equalization with the atmosphere 6, so that, owing to the capillary action, a sample quantity stock 13 rises through the capillary tip 1 into the interior of the capillary tube 2.

In a preferred embodiment, the capillary tube 2 consists of glass, and the external diameter of the capillary tip is in the range from 10 μm to 1000 μm; in particularly preferred embodiments of the capillary tube proposed in accordance with the invention, the external diameter of the capillary tip is in the range from 50 μm to 300 μm. In order to take up the biopolymer solution samples to be applied to the surfaces 14 of support material 4, the capillary tip 1 of the capillary tube 2 is dipped into the solution present in the container 3. The solutions can be located, for example, in the wells 3 of a microtiter plate which can accommodate 96 or 384 or even 1536 individual samples. During dipping of the capillary tip 1 into the solution, the valve 7, which controls the feed of a gas stream into the capillary tube 2, initially remains closed. By contrast, the valve 5, which is connected to the capillary tube 2 by means of the flexible feed line 19 at the T-piece 11, is opened and thus causes pressure equalization to the ambient atmosphere 6. Owing to the capillary force which arises, a liquid stock 13 moves from the well 3 of the microtiter plate into which the capillary tip 1 is dipped at that time into the interior of the capillary tube 2.

The capillary tip 1 is then removed from the presentation solution, subsequently moved in the X- and Y-direction positioned above the surface 14 of a support 4, onto which the individual liquid samples to be analyzed are then applied in a biopolymer pattern 15 while maintaining precisely defined separations 16 from one another. During lowering of the capillary tip 1 in direction 12 (Z-direction) onto the surface 14 of the support 4, the setting of the first valve 5 and the setting of the second valve 7 are not changed. By means of an addressing device 20, which causes movement of the capillary tube 2 in the X-direction, Y-direction and Z-direction, the capillary tip 1 can be lifted off the surface 14 of the support material 4 again in a very simple and inexpensive manner with the involvement of a commercially available plotter, with a small spot of biopolymer solution remaining on the surface 14 of the support material 4. Through suitable addressing 20 of a plotter, employed by way of example, movement of the capillary tube 2 together with liquid stock 13 taken up therein in the X- and Y-direction can be carried out in accordance with the addressing of the plotter, so that successive further support surfaces 14 of support material 4 can be provided with biopolymer spots in the same way. The biopolymer spots are preferably applied in a regular pattern 15, the biopolymer pattern preferably being distinguished in that the individual sample spots have a uniform separation 16 from one another.

Before take-up of a new sample, i.e. before immersion into a new presentation vessel 3, the capillary tip 1 must be cleaned thoroughly in order to avoid sample entrainment. To this end, the capillary tip 1 is initially moved over a waste vessel 9; the first valve 5, which connects to the atmosphere 6, is then closed, and a gas stream, preferably filtered air or nitrogen, is admitted into the interior of the capillary tube 2 via the flexible feed line 19 through the second miniature valve 7.

For thorough washing, the capillary tip 1 is then moved over a washing vessel 10, whereupon, after closure of the second miniature valve 7, i.e. the gas valve, and opening of the first miniature valve 5, i.e. the external air valve, the capillary tip 1 is lowered into the washing liquid. Due to the capillary force which arises, the washing liquid then flows into the interior of the capillary tube 2. The capillary tip 1 of the capillary tube 2 is subsequently moved over the waste vessel 9 again, and the washing liquid is ejected by opening the second miniature valve 7 and closing the first miniature valve 5 to the atmosphere 6. Alternatively, this can also be carried out into the washing liquid in the setting in the immersed state if it is ensured that the washing liquid in the washing vessel 10 is constantly replaced, for example by means of continuous pumping. To this end, the washing vessel 10 can be assigned a pump circuit 17 for the washing fluid, in which firstly fresh, unused washing fluid can be fed to the washing vessel 10, and secondly already used washing liquid or deposited particles are removed continuously at the base of the washing vessel.

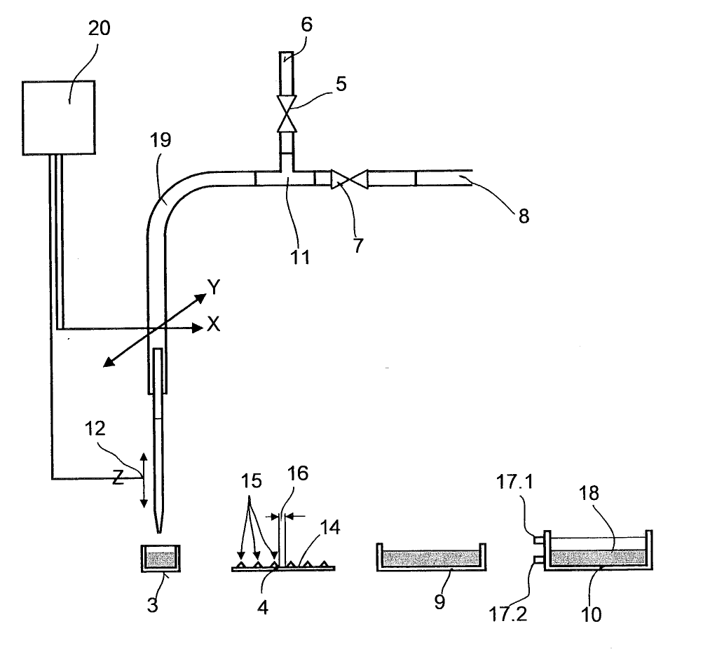

The take-up and ejection of washing fluid from the interior of the capillary tube 2 can be carried out as often as desired through corresponding actuation of the two miniature valves 5 and 7, which are preferably designed as constricted tube valves, until the interior of the capillary tube 2 and its outside have been cleaned sufficiently, and application of biopolymer arrays to the upper side 14 of support substrates 4 to be charged can then continue. The construction of the apparatus represented in FIG. 1 is described in greater detail with reference to an illustrative embodiment. A small support for two miniature constricted tube valves is clamped to the carriage of a commercially available plotter which can be moved in the X- and Y-directions (for example ROLAND DXY 1150A). A tip 1 having an external diameter of about 200 μm was drawn out from a glass micropipette 2, for example a borosilicate glass capillary from Hilgenberg, external diameter 1.0 mm, internal diameter 0.8 mm, in a gas flame. The external diameter of the glass pipette 2 (1 mm) fits in a flush manner, but with sufficiently small play, into the stainless steel cannula of a 1.5×100 syringe. This cannula can be mounted in a simple manner as guide element to the spring clip of a commercially available plotter which can be moved in the X- and Y-direction. The glass micropipette 2 can easily be moved in the vertical direction in this guide cannula and is not pressed downward by the flexible tube 19. Alternatively, this force can be supported by a small spring.

The guide element, which accommodates the capillary tube 2, can be moved up and down by means of the commands “pen up” and “pen down” on the plotter, addressed via a commercially available PC. The connection to the capillary tube 2 is made via the T-connector 11 provided in the feed line from the valves 5, 7 to the flexible tube 19.

Surprisingly, it has been found that this arrangement enables as many support plates 4 as can be accommodated on the DIN A3 working area of the plotter used in addition to the presentation microtiter plate to be charged with a liquid stock 13 by means of a single filling of the interior of the capillary tube 2. In the production of supports 4 with biopolymer patterns 15 of nucleic acid, it has been found that two washing steps in a solution of 0.5% TWEEN-80 are normally entirely sufficient to exclude sample entrainment, which has an adverse effect in practice. It must be ensured when cleaning the glass capillary 2 that the capillary tip 1 is wetted on the inside by washing fluid, which can be ejected out of the interior of the glass capillary again via the gas stream to be applied, controllable by the second miniature valve 7. By immersion of the capillary tip 1 of glass into a vessel containing washing fluid, it is ensured that the outside of the capillary tip 1 also comes into contact with the washing fluid and in this way is in each case cleaned from residues of the previously analyzed sample. During blowing-out of the washing fluid in the immersed state of the capillary tube 2, it is observed that, due to bubble formation in the washing solution, the outside of the capillary of the capillary tube 2 is also washed thoroughly by means of the bubble rising at the capillary 2 during this operation.

The proposed arrangement holds the promise of an enormous economic advantage compared with the charging arrangements conventional hitherto. On the one hand, the availability of commercially available capillary tubes 2 purchased very precisely compared with the production of precisely ground and specially shaped metal pins plays a role, and on the other hand X/Y plotters can be purchased very inexpensively as automatic addressable positioning stages and incorporated into a system proposed in accordance with the invention for the production of biopolymer arrays on surfaces of supports.

List of Reference Symbols

1. Capillary tip

2. Capillary tube

3. Substrate container

4. Support

5. First miniature valve

6. Atmosphere

7. Second miniature valve

8. Gas stream supply line

9. Waste vessel

10. Washing vessel

11. T-connector

12. Z-direction movement of capillary tube 2

13. Taken-up sample

14. Support surface

15. Biopolymer pattern

16. Separation

17.1 Washing fluid feed

17.2 Washing fluid outlet

18. Washing fluid level

19. Flexible feed line

20. Addressing device

X-direction

Y-direction

Z-direction (application direction)

1. A process for the production of biopolymer fields (15) on surfaces (14) of support substrates (4), where the biopolymers to be applied are taken from one or more different sample stocks (3), wherein, a multidimensionally movable capillary tip (1) of a capillary tube (2) is, for the transfer of extremely small liquid quantities to substrate surfaces (14), addressed via a miniature valve (5) serving for filling and via a miniature valve (7) serving for rinsing of the capillary tube (2).

2. A process as claimed in claim 1, wherein a plurality of capillary tubes (2) are connected to the miniature valves (5), (7).

3. A process as claimed in claim 2, wherein the plurality of capillary tubes (2) are operated in parallel to one another.

4. A process as claimed in claim 2, wherein the separation at which the plurality of capillary tubes (2) are arranged to one another corresponds to the separation of the stock vessels (3) to one another on a presentation plate.

5. A process as claimed in claim 1 and/or 2, wherein the one or more capillary tubes (2) can be moved in the X- and Y-directions and execute an immersion movement (12) in the Z-direction in order to take up a liquid stock (13) from the sample container (3).

6. A process as claimed in claim 1 and/or 2, wherein a commercially available computer-supported plotter is employed for moving the one or more capillary tubes (2) in the X-direction and Y-direction.

7. A process as claimed in claim 1 and/or 2, wherein a computer-supported positioning stage is employed for moving the one or more capillary tubes (2) in the X-direction or Y-direction.

8. An apparatus for the production of biopolymer fields (15) on surfaces (14) of support substrates (4), where the biopolymers to be applied are taken from one or more different sample stocks (3), wherein one or more multidimensionally movable glass capillary tubes (2) with capillary tip (1) are, for the transfer of extremely small liquid quantities to substrate surfaces (14), addressed via a first miniature valve (5) serving for filling and via a miniature valve (7) serving for rinsing of the capillary tube (2).

9. An apparatus as claimed in claim 8, wherein the capillary tips (1) have been drawn out to an external diameter in the range from 10 μm to 1000 μm at the end which takes up liquid.

10. An apparatus as claimed in claim 9, wherein the capillary tube tip (1) has an external diameter of from 50 μm to 300 μm at the end which takes up liquid.

11. An apparatus as claimed in claim 8, wherein the addressing of one or more capillary tubes (2) is effected by a computer-supported X/Y plotter, which causes movement of the capillary tube(s) (2) in the X-direction and/or Y-direction.

12. An apparatus as claimed in claim 8, wherein the miniature valves (5), (7) are in the form of constricted tube valves.

13. An apparatus as claimed in claim 12, wherein the constricted tube valves (5), (7) are designed as stops surrounding a flexible feed line (19) to the glass capillary (2), one of which stops is fixed relative to the flexible tube line (19) and the other of which is movable with respect to the fixed stop, for narrowing the cross section in order to effect a closure in the flexible tube line (19).
